(19) United States
(12) Patent Application Publication
(10) Pub. No.: US 2017/0118635 A1
(43) Pub. Date: Apr. 27, 2017

(54) KEY SEPARATION FOR LOCAL EVOLVED PACKET CORE

(71) Applicant: NOKIA SOLUTIONS AND NETWORKS OY, Espoo (FI)

(72) Inventors: Anja JERICHOW, Grafing (DE); Guenther HORN, Munich (DE)

(21) Appl. No.: 14/923,347

(22) Filed: Oct. 26, 2015

(51) Int. Cl. H04W 12/04; H04W 12/08

(52) U.S. Cl. CPC H04W 12/04; H04W 12/08

(57) ABSTRACT

Various communication systems may benefit from appropriate security mechanisms. For example, isolated operation of evolved universal terrestrial radio networks may benefit from key separation for a local evolved packet core. A method can include deriving a subscriber key corresponding to an isolated operation network. The subscriber key can be derived from an identifier of the isolated operation network and a master subscriber key. The method can also include provisioning the subscriber key to the isolated operation network.

### BACKGROUND

Field

Various communication systems may benefit from appropriate security mechanisms. For example, isolated operation of evolved universal terrestrial radio networks may benefit from key separation for a local evolved packet core.

Description of the Related Art

Public safety organizations consider long term evolution (LTE) to be a next generation technology for augmenting existing and defining new critical communication systems. Such organizations may desire to keep communication secure while ensuring that public safety users can continue communication within mission critical situations. Thus, such organizations may desire security for evolved universal terrestrial radio access network (E-UTRAN).

Such security may relate to isolated operation of E-UTRAN for public safety (IOPS) users but also for isolated operation of E-UTRAN in commercial scenarios. In the following, the term IOPS network should be understood to the network regardless of the specific use of for public safety or for commercial use, or for any combination thereof.

The isolated E-UTRAN network may include a single or multiple access nodes, such as single isolated IOPS-capable evolved Node B (eNB) (or a deployable IOPS-capable eNB), which can be connected to a local Evolved Packet Core (EPC) that includes at least a local mobility management entity (MME) and a local home subscriber server (HSS) with a local authentication center (AuC). For example, an IOPS network can be mounted on a firetruck with a command center and can enable firemen to communicate on the site of a disaster.

An IOPS-enabled UE is an UE that is configured to use at least one network operating in IOPS mode. The UE may connect to several IOPS networks over time in order to allow for flexible deployment when the wide area network is not available. In this example, such an arrangement would allow a firefighter to be assigned to teams with different command centers.

3GPP TS 22.346 specifies requirements for Isolated E-UTRAN and is hereby incorporated herein by reference in its entirety. The IOPS architecture is specified in 3GPP TR 23.797, with normative text added to 3GPP TS 23.401, Annex K (informative). Both 3GPP TR 23.797 and 3GPP TS 23.401, Annex K, are hereby incorporated herein by reference in their entirety. IOPS security is discussed in 3GPP TR 33.897, which is also hereby incorporated herein by reference.

The initial version of IOPS networks may have no connectivity to a wide area or macro mobile network, and, in particular, no connectivity to a macro home subscriber server (HSS). Likewise, these IOPS network may not be connected among each other. Subscriber credentials that are the counterpart to those stored on a universal subscriber identity module (USIM) may need to be stored in a local AuC of each IOPS network. The local AuC may be part of the local EPC. One element of the subscriber credentials can be the long-term subscriber key K.

FIG. 1 illustrates current understanding of usage of subscriber key K according to 3GPP TS 23.401 and 3GPP TR 33.897. An assumption in 3GPP TR 33.897 has been that the same long-term subscriber key K is replicated in each local AuC when the UE is to connect to several IOPS network, as shown in FIG. 1.

Potentially, one of these local AuCs could be compromised by an attacker. For example, an attacker could obtain key K or the attacker could control the interface to the local AuC and have the local AuC generate authentication vectors for the attacker.

One way to address such an attack would be for the USIMs out in the field to be swapped and the subscriber credentials to be re-provisioned in all local AuCs. This could be done for all subscribers whose credentials were stored in the compromised local AuC.

### SUMMARY

According to certain embodiments, a method can include deriving a subscriber key corresponding to an isolated operation network. The subscriber key can be derived from an identifier of the isolated operation network and a master subscriber key. The method can also include provisioning the subscriber key to the isolated operation network.

In certain embodiments, a method can include receiving a first identifier of an isolated operation network. The method can also include mapping the first identifier to a second identifier configured to activate an application containing a subscriber key corresponding to the isolated operation network. The subscriber key can be derived from a master subscriber key using the first identifier. The method can further include applying the second identifier in using the isolated operation network.

A method, according to certain embodiments, can include receiving a second identifier configured to activate an application corresponding to an isolated operation network. The method can also include mapping the second identifier to a first identifier configured to identify the isolated operation network. The method can further include operating in the isolated operation network based on the first identifier.

An apparatus, in certain embodiments, can include at least one processor and at least one memory including computer program code. The at least one memory and the computer program code can be configured to, with the at least one processor, cause the apparatus at least to derive a subscriber key corresponding to an isolated operation network. The subscriber key can be derived from an identifier of the isolated operation network and a master subscriber key. The at least one memory and the computer program code can be configured to, with the at least one processor, cause the apparatus at least to provision the subscriber key to the isolated operation network.

According to certain embodiments, an apparatus can include at least one processor and at least one memory including computer program code. The at least one memory and the computer program code can be configured to, with the at least one processor, cause the apparatus at least to receive a first identifier of an isolated operation network. The at least one memory and the computer program code can also be configured to, with the at least one processor, cause the apparatus at least to map the first identifier to a second identifier configured to activate an application containing a subscriber key corresponding to the isolated operation network. The subscriber key can be derived from a master subscriber key using the first identifier. The at least one memory and the computer program code can further be configured to, with the at least one processor, cause the apparatus at least to apply the second identifier in using the isolated operation network.

In certain embodiments, an apparatus can include at least one processor and at least one memory including computer program code. The at least one memory and the computer program code can be configured to, with the at least one processor, cause the apparatus at least to receive a second identifier configured to activate an application corresponding to an isolated operation network. The at least one memory and the computer program code can also be configured to, with the at least one processor, cause the apparatus at least to map the second identifier to a first identifier configured to identify the isolated operation network. The at least one memory and the computer program code can further be configured to, with the at least one processor, cause the apparatus at least to operate in the isolated operation network based on the first identifier.

According to certain embodiments, an apparatus can include means for deriving a subscriber key corresponding to an isolated operation network. The subscriber key can be derived from an identifier of the isolated operation network and a master subscriber key. The apparatus can also include means for provisioning the subscriber key to the isolated operation network.

In certain embodiments, an apparatus can include means for receiving a first identifier of an isolated operation network. The apparatus can also include means for mapping the first identifier to a second identifier configured to activate an application containing a subscriber key corresponding to the isolated operation network. The subscriber key can be derived from a master subscriber key using the first identifier. The apparatus can further include means for applying the second identifier in using the isolated operation network.

An apparatus, according to certain embodiments, can include means for receiving a second identifier configured to activate an application corresponding to an isolated operation network. The apparatus can also include means for mapping the second identifier to a first identifier configured to identify the isolated operation network. The apparatus can further include means for operating in the isolated operation network based on the first identifier.

A computer program product can, in certain embodiments, encode instructions for performing a process. The process can correspond to any of the above-described methods.

According to certain embodiments, a non-transitory computer-readable medium can be encoded with instructions that, when executed in hardware, perform a process. The process can correspond to any of the above-described methods.

### BRIEF DESCRIPTION OF THE DRAWINGS

For proper understanding of the invention, reference should be made to the accompanying drawings, wherein:

FIG. 1 illustrates current understanding of usage of subscriber key K.

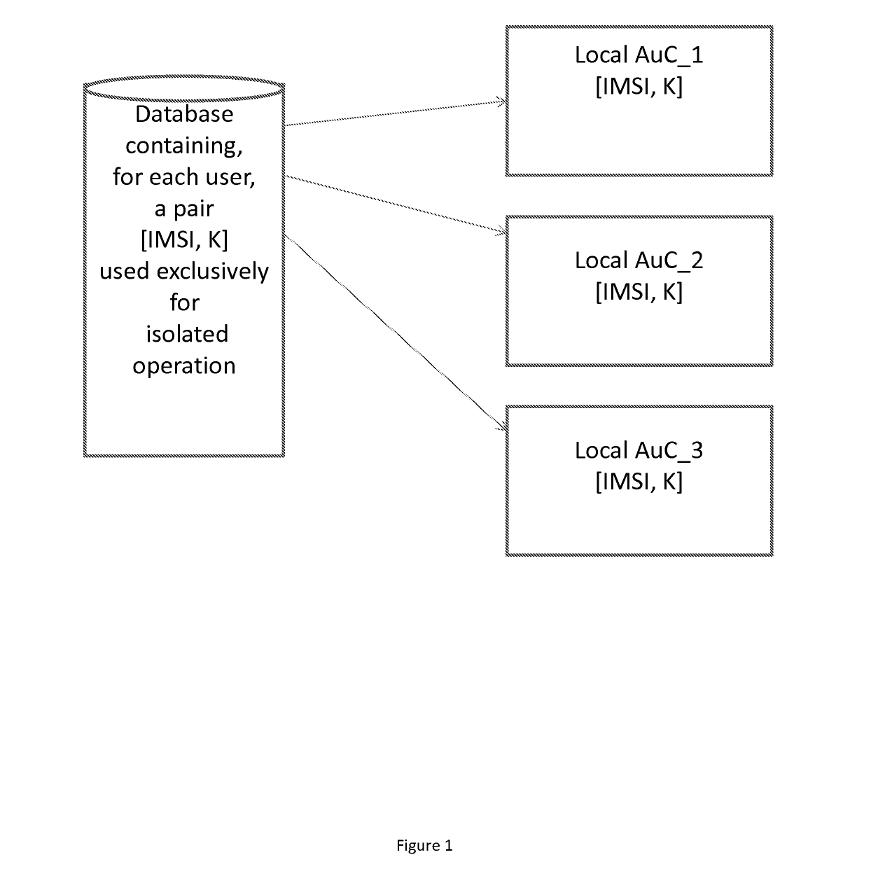

FIG. 2 illustrates provisioning of dedicated local keys derived from a master key, according to certain embodiments.

FIG. 3 illustrates a mobile equipment according to certain embodiments.

FIG. 4 illustrates a universal integrated circuit card according to certain embodiments.

FIG. 5 illustrates a method according to certain embodiments.

FIG. 6 illustrates a system according to certain embodiments.

### DETAILED DESCRIPTION

Certain embodiments may help to mitigate a compromise of one local AuC in an IOPS network in such a way that the USIMs do not need to be swapped and the other local AuCs are not affected.

One approach to address such a compromise may be as follows. For each IOPS network n, to which a user equipment (UE) is supposed to connect at one time, the local AuC_n can be provisioned with a separate long-term subscriber key K_n. Correspondingly, in the UE there can be as many USIMs as there are local AuCs and keys K_n. However, this approach may not scale from a UE point of view, depending on the number of keys K_n. Furthermore, the UE may need a way to find out which USIM on a universal integrated circuit card (UICC) to activate when the UE connects to a particular IOPS network. Although in this discussion UICC is provided as an example, eUICC with several USIMs should be understood to be included in certain embodiments. Additionally, there may need to be mechanism by which a local AuC that has been recognized as compromised can no longer be used for communicating with UEs.

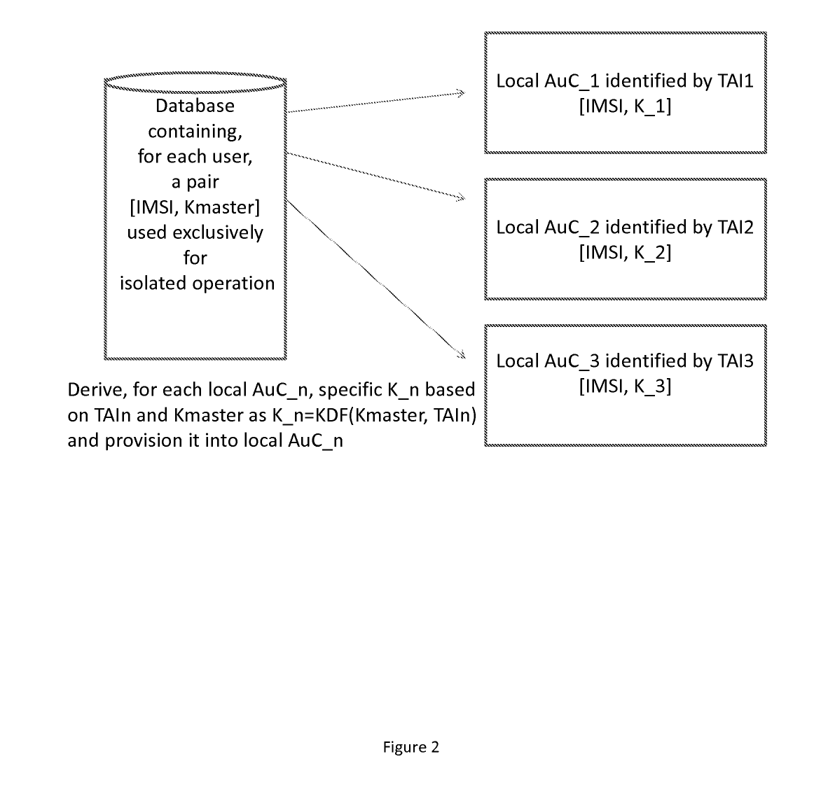

Certain embodiments, therefore, may employ a provisioning process of separate subscriber keys K_n such that they are all derived from a master subscriber key Kmaster. FIG. 2 illustrates provisioning of dedicated local keys derived from a master key, according to certain embodiments.

As shown in FIG. 2, there can be one Kmaster per IOPS subscriber, and there can be one IMSI associated with the Kmaster. The different local AuCs may not get confused by the use of the same IMSI as they may be totally disconnected from each other. In other embodiments, there can be only one internet protocol (IP) multimedia private identity (IMPI) associated with the master subscriber key.

The input parameter for the key derivation function (KDF) that derives K_n from Kmaster can be an identity that identifies the local AuC or the local EPC, or a small group of local AuCs or local EPCs. For example, the system can use the tracking area identifier (TAI) as defined in 3GPP TS 23.003. 3GPP TS 23.003 is hereby incorporated herein by reference in its entirety. The TAI can include mobile country code (MCC), mobile network code (MNC), and tracking area code (TAC). The TAC can have two bytes.

The TAI can be broadcast by the network, and thus known to the UE. The TAI can be used to identify a single local EPC or AuC, or a group of these, under the condition that the IOPS networks are appropriately configured. Thus, K_n=KDF (Kmaster, TAI). As explained above, it is understood that, in this and the following paragraphs, TAI could be replaced with any identity that identifies the local AuC or the local EPC, or a small group of local AuCs or local EPCs.

Any other identifier suitable for identifying a local EPC, local AuC, or group of local EPCs or local AuCs could be used instead of in addition to the TAI. For example, an extended serving network identifier (SN id) could be used in place of TAI to derive K_n. Possibly additional parameters could be input to the KDF as well, such as optional nonces, counters, timestamps, or the like. In the following examples, TAI as used as an input parameter, but TAI could be replaced with or combined with these or any other desired input parameters.

From an IOPS network point of view, a TAI can be permanently associated with a local AuC at the time a subscriber key K_n is provisioned into the local AuC_n so that K_n can be derived from Kmaster before the provisioning takes place (see FIG. 2). For the local AuC_n, K_n can play the role of the long term subscriber key K as defined for LTE security in 3GPP TS 33.401, which is hereby incorporated herein by reference in its entirety.

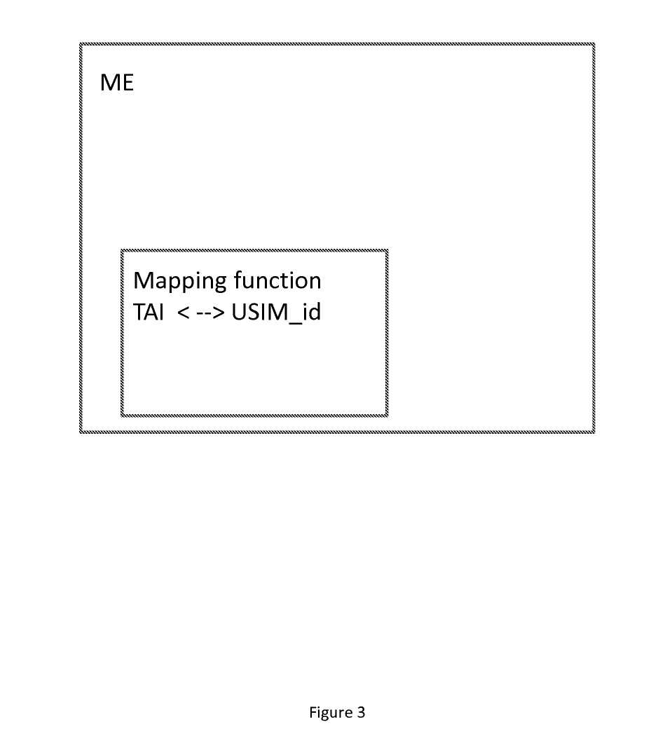

FIG. 3 illustrates a mobile equipment according to certain embodiments. An IOPS mobile equipment (ME) may be, by 3GPP definition, a user equipment (UE) without a UICC. When the ME wants to attach to an IOPS network, the ME can recognize from the TAI that the TAI is related to IOPS. The TAI can be broadcast by the IOPS network. The ME can then map the TAI to an identifier (USIM_id), by which the ME can activate a particular USIM application on the UICC, namely the one that contains the K_n that was derived from Kmaster using this particular TAI. Because IOPS may be a configuration for mission critical push to talk (MCPTT) application, also an IP multimedia Subscriber Identity Module (ISIM) application may contain the K_n. While these are examples of applications, other embodiments may be applied to other applications that may make use of such a derived key.

The TAI can also be transmitted by the ME to the UICC. From the ME point of view, the UICC may hold as many different USIM applications as there are IOPS-related TAIs.

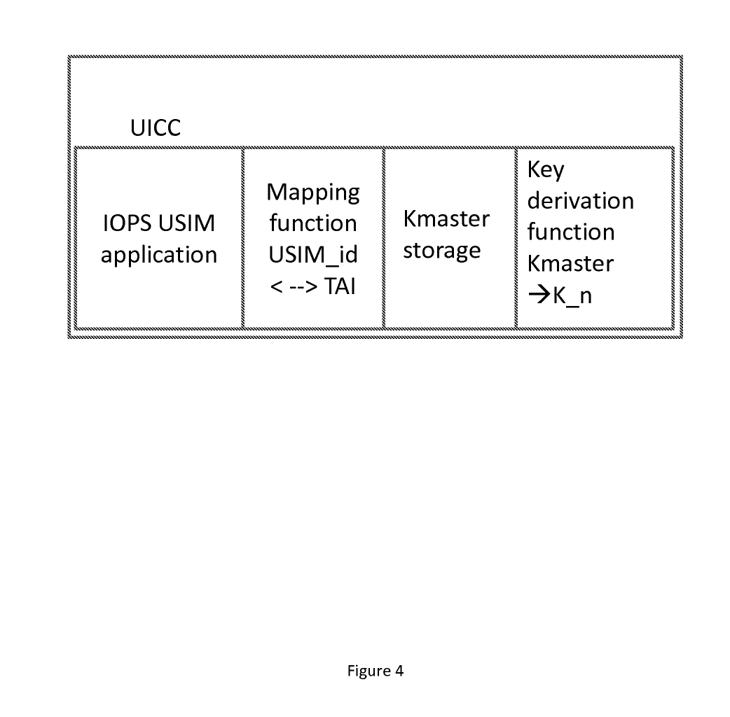

FIG. 4 illustrates a universal integrated circuit card (UICC) according to certain embodiments. In certain embodiments there may be a separate UICC for IOPS purposes. Alternatively, in certain embodiments there may be one UICC for both IOPS purposes and for use with macro networks.

As mentioned above, the UICC can contain a separate USIM application for each subscriber key K_n, as defined in the USIM specification 3GPP TS 31.102. However, in order to address the scalability issues or for other reasons, optimizations inside the UICC can be applied, as explained below.

One possible optimization is as follows. Inside the UICC, there can be a mapping function that can map the USIM application identifier received from the ME at the time of USIM activation to a TAI or other identifier. This mapping function may perform the reverse of the mapping operation that was performed in the ME. This mapping could be provisioned into the UICC. Alternatively, or in addition, the TAI could be sent from the ME to the UICC.

One key Kmaster per IOPS subscriber can be stored in the UICC. Furthermore, the UICC can contain the key derivation function (KDF) that can derive K_n from Kmaster and the TAI at the time of USIM activation. Optionally, additional parameters can be used by the KDF in the key derivation.

The UICC may, for example, contain only one USIM application for IOPS purposes. The master key, Kmaster, may be stored permanently. The subscriber key K used in a current USIM application can be dynamically changed in the following way: the USIM application can contain an extra field for storing the Kmaster. At the time of USIM activation, the UICC can determine the TAI using the mapping function, then derive K_n from Kmaster and TAI. Optionally, additional parameters can be used in the key derivation function. Then, the UICC can use K_n in the same way in which K is used in a current USIM application. All other USIM activities can then be performed, for example, as specified in TS 31.102, which is hereby incorporated herein by reference in its entirety. Thus, the IOPS subscriber key can be dynamically regenerated and changed.

When the UE attaches to an IOPS network, the UE can activate the USIM application dedicated exclusively for IOPS and can derive K_n based on the unique identifier broadcast by the particular local EPC and a stored IOPS master subscriber key. A local MME can run authentication key agreement (AKA) based on the K_n using, for example, EPS AKA procedures. Since K_n is derived, the USIM application may need to keep, in addition to the master subscriber key, only a latest K_n, which can then be replaced by a new K_n when the UE attaches to a different local EPC.

In connection with GBA 3GPP TS 33.220, which is hereby incorporated herein by reference in its entirety, a fully qualified domain name (FQDN) of a server can be included in the derivation as an additional parameter.

In this way, instead of having many separate USIM applications, the UICC may implement one IOPS USIM application with the added functions of storing one permanent key Kmaster (IOPS master subscriber key) and dynamically deriving IOPS subscriber keys K_n from Kmaster using TAI as input, thus avoiding the scalability issues mentioned above.

One of the tasks of a USIM application can be the handling of sequence numbers for the AKA protocol (cf. 3GPP TS 33.401, which refers to 3GPP TS 33.102 for this purpose). Often, an array can be used, as specified in 3GPP TS 33.102, Annex C. The USIM with the added functions could use the same array for all keys K_n and increase a sequence number as if the authentication challenge came from a single AuC, instead of from several local AuCs. This may work because the USIM with the added functions may, in this way, always see sequence numbers in the received authentication challenges that are equal to or higher than those in the local AuCs, hence protection against replay of challenges can continue to be guaranteed.

When a UE moves from one local AuC to the next one, it could happen that the second local AuC generates authentication vectors with a sequence number that is too low as seen from the USIM with the added functions. This may then result in a re-synchronization procedure that may be successful as the AUTS parameter in the re-synchronization procedure can cause the local AuC to update its sequence number and consequently generate an authentication vector that may be accepted by the USIM. This may then result in a successful attach procedure, albeit at the expense of some added delay. If the delay is a concern and re-synchronization procedures may be frequent due to frequent movements of UEs between local AuCs, then this issue may be addressed. For example, this issue may be almost completely avoided by using the IND value of the sequence number to distinguish among local AuCs. For example, the local AuCs can be set up such that they use only particular ND values out of the range of possible IND values. In a typical implementation, ND may have 5 bits, so that 32 local AuCs could be addressed, which may be sufficient.

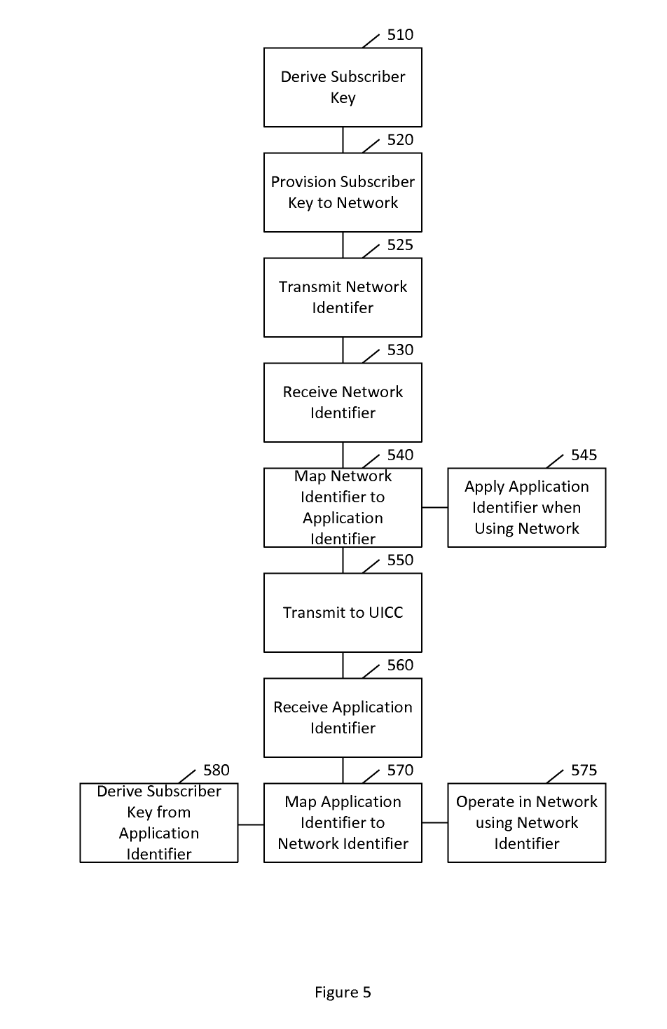

FIG. 5 illustrates a method according to certain embodiments. As shown in FIG. 5, a method can include, at 510, deriving a subscriber key corresponding to an isolated operation network. The subscriber key can be derived from an identifier of the isolated operation network and a master subscriber key. Other parameters of a key derivation function may also be used together with the identifier of the isolated operation network. The method can also include, at 520, provisioning the subscriber key to the isolated operation network.

In certain embodiments, there can be exactly one master subscriber key per subscriber. Moreover, in certain embodiments there can be exactly one international mobile subscriber identity associated with each master subscriber key or there can be exactly one internet protocol multimedia private identity associated with the master subscriber key.

The isolated operation network can be an isolated operation public safety network. Alternatively, as mentioned above, the isolated operation network can be for commercial, mixed, or other use.

The isolated operation network can be an individual network or a group of networks. Thus, the identifier can refer uniquely to the particular isolated operation network or generically to a group of isolated operation networks.

The method can also include, at 530, receiving a first identifier of an isolated operation network. Here, “first” is just to distinguish the identifier from other identifiers being discussed, without any temporal order or order of importance being implied. The method can also include, at 540, mapping the first identifier to a second identifier configured to activate an application containing a subscriber key corresponding to the isolated operation network. The subscriber key can be derived from a master subscriber key using the first identifier. Additional parameters can also be used in this derivation. For example, the subscriber key can be derived from application of a KDF to master subscriber key and additional parameters, including one identifying, for example, the local evolved packet core (EPC). The method can further include, at 545, applying the second identifier in using the isolated operation network.

The first identifier can received in a broadcast message from the isolated operation network, which may be transmitted at 525. The second identifier can be or include a universal subscriber identity module application identifier or internet protocol multimedia subscriber identity module (ISIM) application identifier.

The method can further include, at 550, transmitting the second identifier to a universal integrated circuit card. Moreover, the method can include, at 560, receiving the second identifier configured to activate the application corresponding to the isolated operation network.

The method can further include, at 570, mapping the second identifier to a first identifier configured to identify the isolated operation network. The method can additionally include, at 575, operating in the isolated operation network based on the first identifier.

The method can also include, at 580, deriving the subscriber key corresponding to the isolated operation network based on the second identifier and the master key of the subscriber.

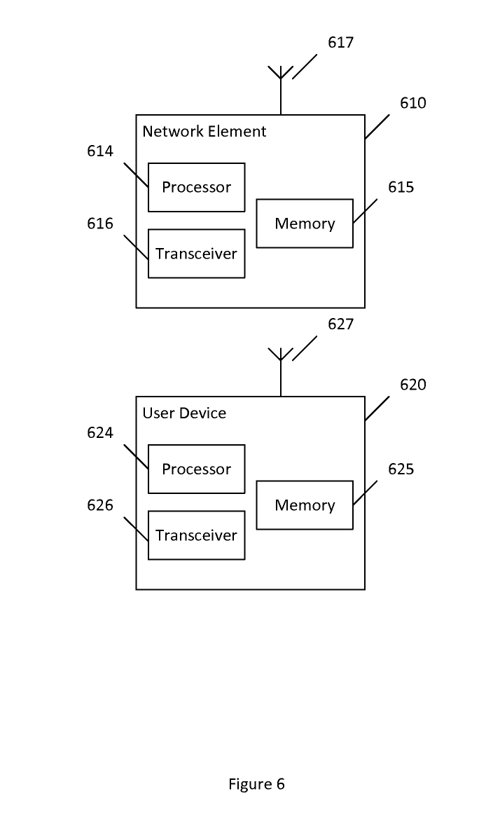

FIG. 6 illustrates a system according to certain embodiments of the invention. It should be understood that each block of the flowchart of FIG. 5 may be implemented by various means or their combinations, such as hardware, software, firmware, one or more processors and/or circuitry. In one embodiment, a system may include several devices, such as, for example, network element 610 and user device 620. The system may include more than one user device 620 and more than one network element 610, although only one of each is shown for the purposes of illustration. A network element can be an access point, a base station, an eNode B (eNB), or any other network element. The user device 620 may be a mobile equipment (ME), user equipment (UE), terminal, sensor, or the like.

Each of these devices may include at least one processor or control unit or module, respectively indicated as 614 and 624. At least one memory may be provided in each device, and indicated as 615 and 625, respectively. The memory may include computer program instructions or computer code contained therein, for example for carrying out the embodiments described above. One or more transceiver 616 and 626 may be provided, and each device may also include an antenna, respectively illustrated as 617 and 627. Although only one antenna each is shown, many antennas and multiple antenna elements may be provided to each of the devices. Other configurations of these devices, for example, may be provided. For example, network element 610 and user device 620 may be additionally configured for wired communication, in addition to wireless communication, and in such a case antennas 617 and 627 may illustrate any form of communication hardware, without being limited to merely an antenna.

Transceivers 616 and 626 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example.

A user device or user equipment 620 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 620 may be a sensor or smart meter, or other device that may usually be configured for a single location. Although not shown in FIG. 6, user device 620 may include or be configured to communicate with a corresponding UICC and/or USIM and/or ISIM, or any similar device.

In an exemplifying embodiment, an apparatus, such as a node or user device, may include means for carrying out embodiments described above in relation to FIG. 5.

Processors 614 and 624 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 615 and 625 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 610 and/or user device 620, to perform any of the processes described above (see, for example, FIG. 5). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 6 illustrates a system including a network element 610 and a user device 620, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may mitigate fragility of a system of several IOPS networks. No changes to network are required. Only configuration changes are required for the ME. Adding some simple functions to the UICC may solve the scalability problem of having many USIMs.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### LIST OF ABBREVIATIONS

UE=User Equipment, UE=ME+UICC
ME=Mobile Equipment
UICC=Universal Integrated Circuit Card
USIM=Universal Subscriber Identification Module

We claim:

1. A method, comprising:
deriving a subscriber key corresponding to an isolated operation network, wherein the subscriber key is derived from an identifier of the isolated operation network and a master subscriber key; and
provisioning the subscriber key to the isolated operation network.

2. The method of claim 1, wherein there is only one master subscriber key per subscriber.

3. The method of claim 1, wherein there is only one international mobile subscriber identity associated with the master subscriber key or there is only one internet protocol multimedia private identity associated with the master subscriber key.

4. The method of claim 1, wherein the isolated operation network comprises an isolated operation public safety network.

5. The method of claim 1, wherein the isolated operation network comprises an individual network or a group of networks.

6. A method comprising:
receiving a first identifier of an isolated operation network;
mapping the first identifier to a second identifier configured to activate an application containing a subscriber key corresponding to the isolated operation network, wherein the subscriber key is derived from a master subscriber key using the first identifier; and
applying the second identifier in using the isolated operation network.

7. The method of claim 6, wherein the first identifier is received in a broadcast message from the isolated operation network.

8. The method of claim 6, wherein the second identifier comprises a universal subscriber identity module application identifier or internet protocol multimedia subscriber identity module application identifier.

9. The method of claim 6, further comprising:
transmitting the second identifier to a universal integrated circuit card.

10. A method, comprising:
receiving a second identifier configured to activate an application corresponding to an isolated operation network;
mapping the second identifier to a first identifier configured to identify the isolated operation network; and
operating in the isolated operation network based on the first identifier.

11. The method of claim 10, further comprising:
deriving a subscriber key corresponding to the isolated operation network based on the second identifier and a master key of the subscriber.

12. An apparatus, comprising:
at least one processor; and
at least one memory including computer program code,
wherein the at least one memory and the computer program code are configured to, with the at least one processor, cause the apparatus at least to
derive a subscriber key corresponding to an isolated operation network, wherein the subscriber key is derived from an identifier of the isolated operation network and a master subscriber key; and
provision the subscriber key to the isolated operation network.

13. The apparatus of claim 12, wherein there is only one master subscriber key per subscriber.

14. The apparatus of claim 12, wherein there is only one international mobile subscriber identity associated with the master subscriber key or there is only one internet protocol multimedia private identity associated with the master subscriber key.

15. The apparatus of claim 12, wherein the isolated operation network comprises an isolated operation public safety network.

16. The apparatus of claim 12, wherein the isolated operation network comprises an individual network or a group of networks.

17. An apparatus comprising:
at least one processor; and
at least one memory including computer program code,
wherein the at least one memory and the computer program code are configured to, with the at least one processor, cause the apparatus at least to
receive a first identifier of an isolated operation network;
map the first identifier to a second identifier configured to activate an application containing a subscriber key corresponding to the isolated operation network, wherein the subscriber key is derived from a master subscriber key using the first identifier; and
apply the second identifier in using the isolated operation network.

18. The apparatus of claim 17, wherein the first identifier is received in a broadcast message from the isolated operation network.

19. The apparatus of claim 17, wherein the second identifier comprises a universal subscriber identity module application identifier or internet protocol multimedia subscriber identity module application identifier.

20. The apparatus of claim 17, wherein the at least one memory and the computer program code are configured to, with the at least one processor, cause the apparatus at least to transmit the second identifier to a universal integrated circuit card.

21. An apparatus, comprising:
at least one processor; and
at least one memory including computer program code,
wherein the at least one memory and the computer program code are configured to, with the at least one processor, cause the apparatus at least to
receive a second identifier configured to activate an application corresponding to an isolated operation network;
map the second identifier to a first identifier configured to identify the isolated operation network; and
operate in the isolated operation network based on the first identifier.

22. The apparatus of claim 21, wherein the at least one memory and the computer program code are configured to, with the at least one processor, cause the apparatus at least to derive a subscriber key corresponding to the isolated operation network based on the second identifier and a master key of the subscriber.
